(19) United States
(12) Patent Application Publication
(10) Pub. No.: US 2009/0083089 A1
(43) Pub. Date: Mar. 26, 2009

(54) SYSTEMS AND METHODS FOR ANALYZING FAILURE MODES ACCORDING TO COST

(75) Inventors: John Anthony Conchieri, Greenfield, NY (US); Michael J. Dell'Anno, Clifton Park, NY (US); Ronald P. Wiederhold, Schenectady, NY (US); Edward Hardwicke, Greenville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/859,199

(22) Filed: Sep. 21, 2007

(51) Int. Cl. G06Q 10/00

(52) U.S. Cl. 705/7

(57) ABSTRACT

Disclosed are systems, methods, and computer readable media for analyzing failure modes derived from a failure modes and effects analysis. One or more failure modes for a product are identified. A respective cost exposure for each of the identified one or more failure modes is determined in order to provide the criticality and risk of a product's failure modes in financial terms. The one or more failure modes can then be prioritized in accordance with the determined cost exposure.

### FIELD OF THE INVENTION

The invention relates generally to systems and methods for analyzing failure modes derived from a failure mode and effect analysis (FMEA), and, more particularly, to systems and methods for analyzing failure modes according to their cost exposure.

### BACKGROUND OF THE INVENTION

Failure mode and effect analysis (FMEA) is used in many industries for evaluating system, component, or process failures. Typically, failure modes that are identified with an FMEA are evaluated and prioritized according to their criticality and risk. More specifically, failure modes are typically evaluated according to their severity, the probability of their occurrence, and the likelihood that they will be detected. Failure modes can then be prioritized based on a combination of these three criteria.

As a result of the typical failure mode analysis, it is difficult to directly import the failure mode data into business risk models or to conduct a financial analysis of the data. Instead, scale factors derived from the three criteria discussed above and an analyst's judgment may be used to interpret a failure mode's potential cost impact. This process can be error prone and may undermine the accuracy of the financial analysis.

Thus, there is a need to develop reliable cost of failure assessments for failure modes that can be used in financial models and for future planning. There is a need for systems and methods for analyzing failure modes derived from a failure mode and effect analysis according to cost.

### BRIEF DESCRIPTION OF THE INVENTION

This Brief Description is provided to introduce a selection of concepts in a simplified form that are further described below in the Detailed Description and is not intended to limit the scope of the claimed subject matter. Embodiments of the invention are directed generally to systems and methods for providing a cost of failure analysis to one or more failure modes derived from a failure mode and effect analysis (FMEA).

According to one embodiment of the invention, a method for analyzing the costs associated with a failure mode for a product is provided. This method may include identifying and analyzing one or more failure modes of a product. A cost exposure may be determined for each of the one or more analyzed failure modes. The cost exposure for each of the analyzed failure modes may reflect the criticality and risk of failure in financial terms.

According to another embodiment of the invention, a system for analyzing the cost exposure of one or more failure modes for a product is provided. The system may include a memory operable to store data associated with failure modes for the product. The system may also include a processor operable to identify one or more failure modes for the product, to access the stored data associated with the identified one or more failure modes, and to determine a cost exposure associated with each of the one or more identified failure modes.

According to yet another embodiment of the invention, a computer-readable medium is provided. The computer-readable medium may include program code operable to identify one or more failure modes for a product and access stored data associated with the product. The program code may also be operable to determine, based at least in part on the accessed data, a respective cost exposure for at least one of the identified one or more failure modes. Additionally, the program code may be operable to prioritize the identified one or more failure modes based on the determined cost exposures.

Aspects of the invention may apply to both the system and method for analyzing the cost exposure of a product's failure modes. According to one aspect, the cost analyzed failure modes may be prioritized according to their determined cost exposures to provide a relative assessment of their criticality and risk amongst multiple failure modes. The analyzed failure mode information may also be displayed for further analysis or synthesis.

According to another aspect of the invention, a total cost exposure for one or more failure modes may be determined based at least in part on the total number of failure events associated with the analyzed failure mode, a failure mode's fixed cost of repair, and a failure mode's variable cost of repair.

Other embodiments and aspects of the invention will become apparent from the following description taken in conjunction with the following drawings.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an exemplary system that may be used to conduct a cost analysis of failure modes derived from a failure mode and effect analysis (FMEA).

FIG. 2 is a block diagram of an exemplary control unit that may perform a cost exposure analysis of failure modes derived from an FMEA.

FIGS. 3 and 4 are exemplary flowcharts depicting the operation of the control unit of FIG. 2, according to an illustrative embodiment of the invention.

FIG. 5A is an exemplary chart that illustrates fixed cost data for an exemplary product that may be analyzed in accordance with certain embodiments of the invention.

FIG. 5B is an exemplary chart that illustrates variable cost data for an exemplary product that may be analyzed in accordance with certain embodiments of the invention.

FIG. 6 is an exemplary display showing cost analyzed and prioritized failure modes using the exemplary data provided in FIGS. 5A and 5B.

### DETAILED DESCRIPTION OF THE INVENTION

The invention now will be described more fully hereinafter with reference to the accompanying drawings, in which example embodiments of the invention are shown. This invention may, however, be embodied in many different forms and should not be construed as limited to the example embodiments set forth herein. Like numbers refer to like elements throughout.

Embodiments of the invention are described below with reference to block diagrams and schematic illustrations of methods and systems according to embodiments of the invention. It will be understood that each block of the diagrams, and combinations of blocks in the diagrams can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

Embodiments of the invention can be implemented in a business risk model or planning process and system. By doing so, a financial analyst, or other individual or entity analyzing the cost impacts of a product's failure modes, may make informed decisions regarding the impact or cost associated with a failure mode. Accordingly, embodiments of the invention described herein may facilitate the avoidance of subjective determinations when analyzing the cost exposure of a failure mode. Embodiments of the invention may link an objective, quantifiable cost assessment to each failure mode to determine its criticality and risk, as reflected in its cost exposure, and minimize errors introduced through subjective determinations. Thus, the technical effect is to provide a cost assessment for identified failure modes of a product.

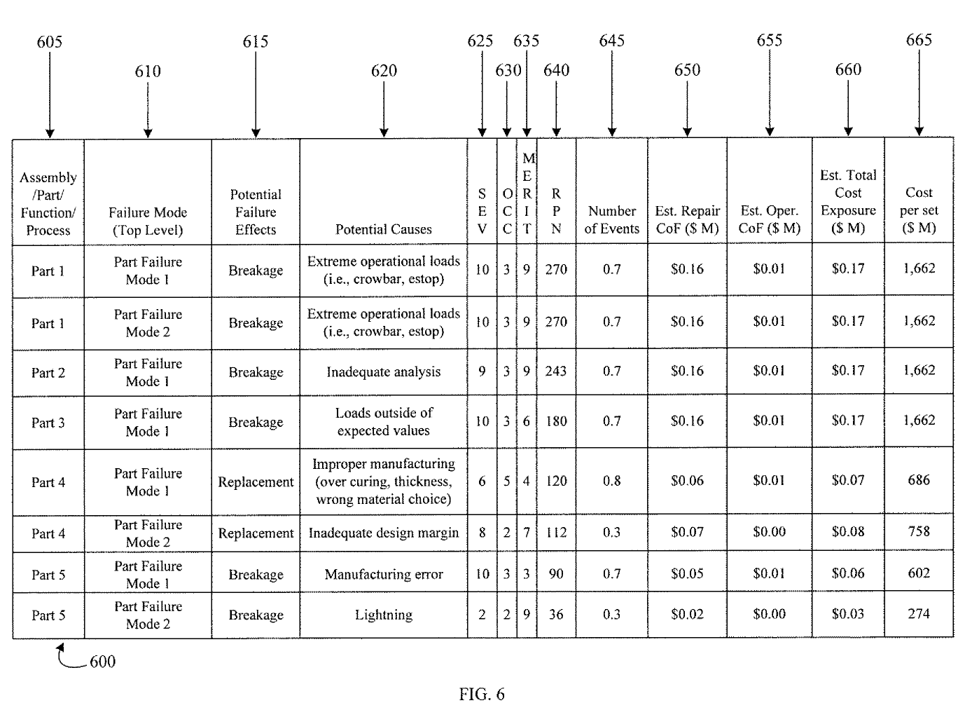

Moreover, embodiments of the invention may also improve upon traditional failure mode and effect analysis (FMEA) tools and methods. The FMEA is commonly used in many industries for evaluating the criticality and risk of a product's failure modes. Typically, FMEA tools and methods evaluate a product's failure modes according to their severity, likelihood of occurrence, and likelihood of detection. An example of a traditional evaluation for one example of a product is depicted in several columns 625, 630, 635, and 640 of FIG. 6, and discussed in greater detail below. Such an analysis prioritizes failure modes based on their criticality and risk of harm as determined by these factors. There is no known integrated FMEA tool and method that evaluates a product's failure modes according to financial terms. The invention described herein fills this gap by evaluating the cost exposure of each failure mode to reflect its criticality and risk in financial terms.

In an exemplary embodiment, the failure modes and certain costs associated with a product are collected. The product may include a system, a process, a component, or a combination of one or more systems, one or more processes, and one or more components. The collected data may be stored in one or more appropriate memory devices for subsequent cost analysis. The collected data may be analyzed to determine a respective cost exposure for each of one or more identified failure modes for the product. A priority may be determined for each failure mode by comparing its cost exposure to the cost exposures of one or more other cost analyzed failure modes. It will be appreciated that the cost analysis that is performed in accordance with embodiments of the invention may be performed independent of any safety related analysis of failure modes.

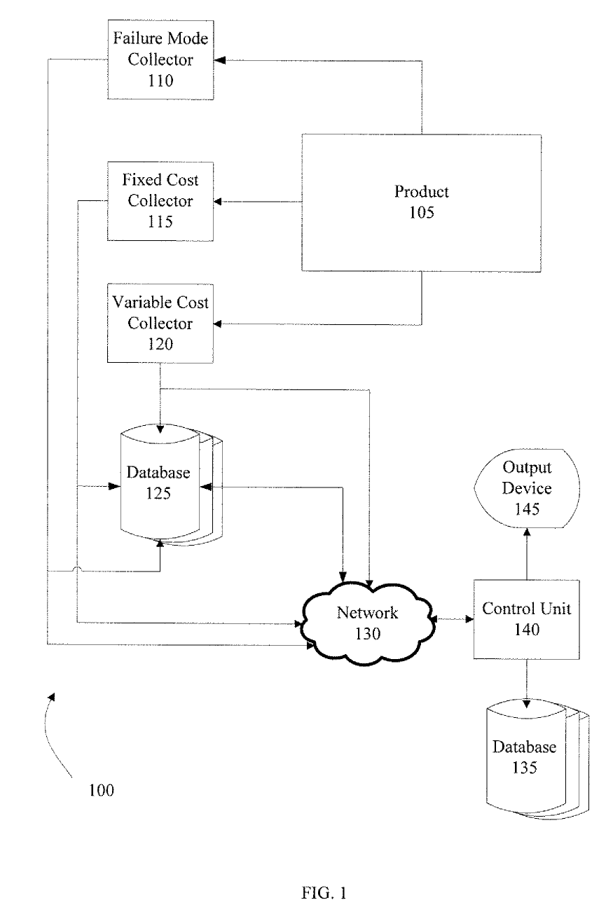

FIG. 1 illustrates an exemplary system 100 that may be used to conduct a cost analysis on one or more failure modes of product 105, according to an illustrative embodiment of the invention. The system 100 may include one or more data collectors 110, 115, 120, one or more memory devices 125, 135, at least one control unit 140, and one or more output devices 145.

The product 105 may be a system, component, process, or a combination of system(s), component(s), or process(es). The one or more data collectors 110, 115, 120 may include a failure mode collector 110, a fixed cost collector 115, and a variable cost collector 120. The one or more data collectors 110, 115, and 120 may be any appropriate data collector, multiple of data collectors, and/or methods for inputting data. For example, the one or more data collectors 110, 115, and 120 may be sensors that collect data in real-time while the product 105 is in operation. As another example, the one or more data collectors 110, 15, and 120 may be outputs or other data received from another system(s) or process(es), such as, for example, a software component, that may be local or remote, and that has processed raw data into failure mode data. As yet another example, the data collectors 110, 115, and 120 may be any appropriate user input device or input mechanism(s) such as, for example, a keyboard, a touchpad, an interactive display, a floppy disk drive, a CD-ROM drive, and/or a portable storage device such as a memory stick, compact flash card, secure digital card and the like. Furthermore, it will be appreciated that the one or more data collectors 110, 1115, and 120 may be embodied as a single data collector, or as a plurality of data collectors.

In the exemplary system of FIG. 1, the failure mode collector 110 may represent the collection of failure mode data associated with the product 105 by any suitable means. It will be appreciated that the failure mode data may include many different types of data associated with one or more failure modes for the product 105. Additionally, it will be appreciated that the failure mode data may facilitate the identification of one or more failure modes and/or failure events for the product 105. Exemplary types of failure mode data include, but are not limited to, a number of failure modes for the product 105, the types of failure modes for the product 105, and a number of failure events for each of the one or more failure modes for the product 105. Each failure mode may be associated with one or more failure events. It will be understood that the data collected by the failure mode collector 110 may include data items and/or references to data items that are stored in an appropriate memory device that may be accessed by one or more components of the system 100.

Similarly, the fixed cost collector 115 may represent the collection by any suitable means of data associated with one or more fixed costs for one or more failure modes for the product 105. The data associated with one or more fixed costs may be applicable to each of the failure modes for the product 105. In other words, the data associated with one or more fixed costs may remain constant across all of the cost analysis that is conducted for the product 105. It will be appreciated that the fixed cost data may include many different types of cost data associated with one or more failure modes. For example, the fixed cost data may include data associated with a start cost that is incurred to start the product 105 either initially or following a shutdown or repair operation. The start cost may take a variety of factors into account such as, for example, the fuel, labor, and any parts that are needed for a start operation. As another example, the fixed cost data may include maintenance hour costs associated with the product 105. The maintenance hour cost may be expressed as a maintenance hour cost over a predefined period of time such as, for example, an hourly cost. The maintenance hour cost may represent the cost per hour this incurred due to downtime of the product 105. For example, if the product 105 is a power generation system, the maintenance hour cost may represent the cost of obtaining replacement power for the power that is lost due to the downtime of the product 105. In addition to the exemplary cost-specific fixed costs discussed above, the fixed cost data may also include data that is associated with one or more failure modes but is not necessarily cost-specific. For example, the size of a given population of the product 105 or one or more components of the product 105, an evaluation period for the cost analysis, or a factor that represents efficiency gains from maintenance or logistical proficiency may be fixed cost data. An evaluation period may be any suitable evaluation period for a cost analysis of one or more failure modes such as, for example, a two-year, five-year, or ten-year period. It will be appreciated that different failure modes may be associated with different evaluation periods or, alternatively, a single evaluation period may be utilized for all of the failure modes for a product 105. A factor that represents efficiency gains as a result of maintenance or logistical proficiency may be a static factor or a dynamic factor that is considered in a cost analysis.

Although the fixed cost data is described herein as remaining constant across the one or more failure modes of the product 105, it will be appreciated that fixed cost data may vary for different failure modes of a product. For example, a first failure mode and a second failure mode for a product 105 may be associated with different maintenance costs.

The variable cost collector 120 may represent the collection by any suitable means of data associated with one or more variable costs for one or more failure modes of the product 105. The variable cost data may include data associated with only one failure mode. However, it will be appreciated that at least a portion of the variable cost data may also apply to more than one failure mode for the product 105. Exemplary variable cost data may include data describing the characteristics of a failure mode such as, for example, a failure period for the failure mode, also referred to as a Mean Time Between Failure (MTBF). A MTBF may represent an average operating time for the product 105 between each failure event for a given failure mode. The average operating time may be expressed as any suitable time such as, for example, an average number of hours between each failure event. Another example of variable cost data is an estimated repair time for a failure mode, referred to as a Mean Time To Repair (MTTR). Similar to the MTBF, the MTTR may represent an average number of hours for a repair. Another example of variable cost data may be an estimated repair cost associated with a failure mode and/or a failure event. The estimated repair cost may take a variety of factors into consideration such as, for example, an estimated or actual cost of replacement parts, an estimated or actual cost of tools or equipment utilized in a repair, and an estimated or actual labor cost associated with a repair. Another example of variable cost data is a cost factor that may be associated with one or more failure modes. The cost factor may be utilized to distinguish between planned and unplanned repairs and/or maintenance. The cost factor may take into account the ability to perform planned repairs and/or maintenance more efficiently than unplanned events. It will be appreciated that a wide variety of cost factors may be utilized in accordance with the invention.

The data collected by the failure mode collector 110, the fixed cost collector 115, and the variable cost collector 120, may be stored in one or more appropriate memory devices such as, for example, a database 125 that is accessible by one or more of the other components of the system 100. It will be appreciated that the database 125 may be accessed via an appropriate communications link. For example, the database 125 may be accessed via a network 130 or the database 125 may be in direct communication with or incorporated into the control unit 140.

It will be appreciated that many different types of data associated with failure modes for the product 105 may be collected and/or stored in accordance with the operation of system 100. Data types in addition to those described above will be readily apparent to those of ordinary skill in the art. Additionally, it will be understood that the categorizations of data types discussed above are simply provided for illustrative purposes. The data types that may be utilized in accordance with the operation of the system 100 may be categorized in many different ways.

Database 125 may be similar to database 135. Accordingly, the database 125 may be any suitable storage or memory device, either local or remote to the system 100. Suitable memory devices may include one or more of such electronic storage devices as a random access memory (RAM), a read-only memory (ROM), a flash memory, a storage disk, a hard drive, or other suitable storage devices, as will be understood by those of skill in the art. A suitable storage device may include any appropriate electronic or non-electronic medium such as a chart, a table, a list, or a reference guide. Moreover, it will be understood that the system 100 may include any number of databases and each of these databases may be in communication with one or more components of the system 100.

The network 130 may be any network suitable for transferring data between components of the system 100 or between components of the system 100 and one or more external devices and/or external systems. For example, the network 130 may be a local area network (LAN), a wide area network (WAN), a wireless network, a wired network, a cellular network, or a direct connection between one or more systems that may or may not be involved with failure mode cost analysis.

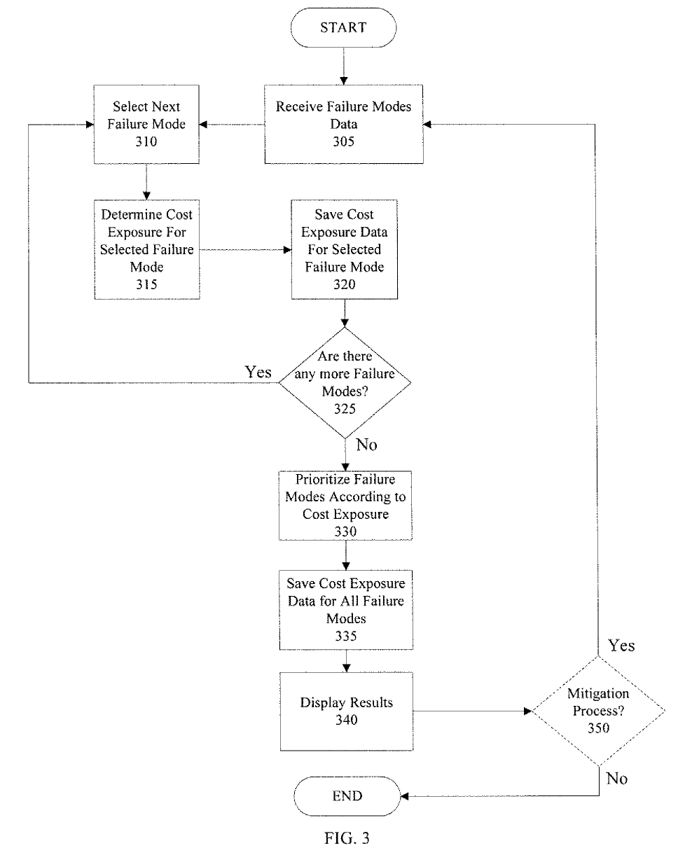

The control unit 140 may represent an exemplary component of the system 100 that identifies and analyzes one or more failure modes associated with the product 105 according to cost and determines a respective cost exposure for each failure mode. After that analysis, which is described in greater detail below with reference to FIGS. 3 and 4, the control unit 140 may cause an output device 145 to display at least a portion of the analysis, at least a portion of the results of the analysis, one or more reports generated from the analysis, and/or summary information generated from or in conjunction with the analysis. The control unit 140 may also direct the storage of data associated with the analysis in a suitable storage or memory device such as, for example, database 135. The control unit 140 may also make at least a portion of the analysis, results, reports, and/or summary data available to other systems via an appropriate communications link such as, for example, the network 130.

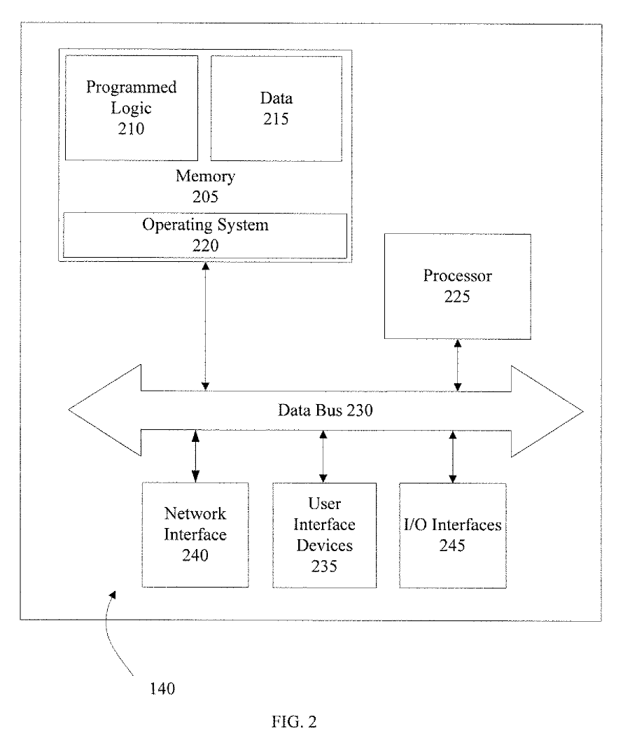

FIG. 2 is a block diagram of an exemplary control unit 140 that may perform a cost exposure analysis of failure modes derived from a failure mode and effect analysis. The control unit 140 may include a memory 205 and a processor 225. The memory 205 may store programmed logic 210 (e.g., software) in accordance with the invention. One example of software or a computer-readable medium can be program code or a set of instructions operable to perform a cost exposure analysis of failure modes derived from a failure mode and effect analysis, or a cost exposure analysis program module. The memory 205 may also include data 215 utilized in the operation of the invention such as, for example, the data associated with product 105 that is gathered by the data collectors 110, 115, and 120, and an operating system 220. A processor 225 may utilize the operating system 220 to execute the programmed logic 210, and in doing so, may also utilize the data 215. A data bus 230 may provide communication between the memory 205 and the processor 225. Users may interface with the control unit 140 via one or more user interface device(s) 235 such as a keyboard, mouse, control panel, or any other device capable of communicating digital data to control unit 140. The control unit 140 may also include one or more network interface(s) 240 that may facilitate communication between the control unit 140 and other components of the exemplary system 100 and/or with external devices, systems, or network stations via a network such as, for example, the network 130 that facilitates communication between the control unit 140 and other components of the system 100 like database 125 and the data collectors 110, 115, and 120. It will be appreciated that many different types of network interfaces may be incorporated into the control unit 140. For example, the one or more network interfaces 240 may include a wireless modem that facilitates network communication with the control unit 140 via the network 130. As another example, the one or more network interfaces 240 may include a cellular network interface that facilitates communication via a cellular network. Furthermore, the control unit 140 and the programmed logic 210 implemented thereby may comprise software, hardware, firmware or any combination thereof. The control unit 140 may be any suitable computing device such as, for example, a desktop or laptop computer.

The control unit 140 may also include one or more I/O Interfaces 245. The one or more I/O Interfaces 245 may be configured to receive input data and/or parameters from an appropriate input device or system such as, for example, from sensors associated with the system 100 that are directly connected to the control unit 140. The one or more I/O Interfaces 245 may also facilitate the output of data by the control unit 140 to one or more suitable output devices 145 and/or to one or more other system components or external devices. For example, the control unit 140 may communicate data to one or more displays via the I/O Interfaces 245. The data communicated to the one or more displays may be data associated with one or more failure modes of the product 105, a cost analysis for the one or more failure modes, and a prioritization of the one or more failure modes.

FIG. 3 is an exemplary flow chart of the general operation of the control unit 140, according to an illustrative embodiment of the invention. Failure mode data may be received at block 305. The received failure mode data may be associated with actual data items such as, for example, the number of failure modes for the product 105, or, alternatively, the received failure mode data may be associated with references to failure mode data stored in an associated memory device. The received failure mode data may be associated with one or more failure modes for the product 105. Additionally, the received failure mode data may be associated with one or more respective causes or failure events for the one or more failure modes. The received failure mode data may also be associated with one or more respective failure effects for the one or more failure modes. The costs associated with a failure mode may reflect or otherwise be associated with one or more causes and/or one or more effects of the failure mode.

At block 310, a failure mode may be identified and selected. The cost exposure for the selected failure mode is determined at block 315, as discussed in greater detail below with reference to FIG. 4. At block 320, the determined cost exposure and at least a portion of the data associated with the analysis of the control unit 140 is optionally saved in a suitable memory device.

At block 325 a determination is made as to whether there are any more failure modes to be analyzed. If it is determined that there are additional failure modes to be analyzed, then operations may continue at block 310 and the next failure mode may be selected. If it is determined that there are no more failure modes to be analyzed, then the control unit 140 may proceed to block 330.

At block 330, the one or more failure modes may be prioritized according to their respective cost exposures. The “cost exposure” may be expressed in financial terms such as, for example, in monetary units, or as time, outage duration, lost opportunity, lost production, or any other suitable measure that may be determined and ranked. The respective cost exposures may be the cost exposures that are determined for each failure mode at block 315. The prioritization may provide a relative assessment of the criticality and risk of each of the one or more failure modes as a function of cost. It will be appreciated that any suitable prioritization method may be utilized in accordance with the invention. For example, the one or more failure modes may be ranked from highest to lowest relative cost exposure. FIG. 6, as discussed further below, displays an exemplary prioritization of the failure modes for one example product according to cost.

With continued reference to FIG. 3, cost exposure data and/or the prioritization may be saved at block 335. At block 340, the data may optionally be displayed or otherwise output to a user in any appropriate form. For example, the form of display may include one or more of a report of at least a portion of the determined cost exposure data, summary information associated with at least a portion of the cost exposure data, and a combination of one or more reports or summary information. FIG. 6, as discussed further below, illustrates an exemplary graphical user interface that may be utilized to display information associated with cost analyzed failure modes.

With continued reference to FIG. 3, block 350 may be optionally performed. At block 350, a mitigation process may be implemented to minimize the criticality and risk of one or more analyzed failure modes. If a mitigation process is implemented at block 350, then operations may continue at block 305 and the analyzed failure modes may be reevaluated to account for changes incurred by the mitigation process. In accordance with other embodiments, many different mitigation processes may be performed such as, for example, preventive maintenance on the product 105.

Although FIG. 3 only describes the determination of a respective cost exposure for one or more failure modes, it will be appreciated that a respective cost exposure may be determined for one or more failure events for a given failure mode. It will further be appreciated that the operations described in FIG. 3 do not necessarily have to be performed in the order set forth in the logic of FIG. 3, but instead may be performed in any suitable order. Additionally, it will be understood that, in certain embodiments of the invention, the control unit 140 may perform more or less than all of the operations set forth in FIG. 3. Furthermore, it will be appreciated that some or all of the operations set forth in FIG. 3 may be performed by a suitable cost exposure analysis program module or computer-readable medium with program code.

FIG. 4 illustrates an exemplary method for block 315 in order to determine the cost exposure of a single failure mode. Fixed cost data is received at block 405 and, as described above, may be associated with the selected failure mode or a plurality of failure modes. For example, the fixed cost data may be associated with all of the failure modes of the product 105 and not simply with the single failure mode being analyzed. Variable cost data for the selected failure mode is received at block 410 and, as described above, may be associated with the single failure mode; however, the variable cost data may be associated with a plurality of failure modes.

At block 415, the total number of failure events for the selected failure mode is received or determined. The total number of failure events parameter may be used to determine the total number of times a failure mode is likely to occur for a given evaluation period. The total number of failure events may be pre-established or preset by the user, received as part of the failure mode data, or determined based at least in part on the fixed cost and/or variable cost data. As discussed further below, FIG. 6 column 645 displays an example for determining the total number of failure events based on the fixed cost data and the variable cost data.

With continued reference to FIG. 4, the fixed cost of failure for the selected failure mode is determined at block 420. The fixed cost of failure may represent a fixed cost associated with all of the failure modes of the product 105. The fixed cost of failure may be determined based at least in part on the failure mode data, the fixed cost data, and/or the variable cost data for the selected failure mode. For example, a fixed cost of failure can be determined by multiplying the number of failure events with the start cost as provided by the fixed cost data, in order to determine a fixed cost of failure for the evaluation period. The number of failure events may be provided by the failure mode data, or determined based at least in part on the variable cost data and the fixed cost data. Moreover, the fixed cost of failure may also be determined as a function of the repair cost of failure and/or the lost operational cost of failure as discussed in greater detail below with reference to FIG. 6.

With continued reference to FIG. 4, at block 425, the variable cost of failure is determined. The variable cost of failure may be determined by summing the repair cost of failure and the lost operational cost of failure. The repair cost of failure and/or the lost operational cost of failure may each be determined based at least in part on a combination of the failure mode data, the fixed cost data, and/or the variable cost data for the selected failure mode, as described in greater detail below with reference to FIG. 6. The repair cost of failure may take the estimated cost of the part and labor for a repair event into account that may be incurred due to downtime for the product 105.

With continued reference to FIG. 4, at block 430 the total cost of failure for the selected failure mode is determined. The total cost of failure may be determined at least in part by a combination of the fixed cost of failure and the variable cost of failure for the selected failure mode. An example of a determined total cost of failure is described in greater detail below with reference to FIG. 6.

It will be appreciated that the operations described in FIG. 4 do not necessarily have to be performed in the order set forth in the logic of FIG. 4, but instead may be performed in any suitable order. Additionally, it will be understood that, in certain embodiments of the invention, the control unit 140 may perform more or less than all of the operations set forth in FIG. 4. Furthermore, it will be appreciated that some or all of the operations set forth in FIG. 4 may be performed by a suitable cost exposure analysis program module or computer-readable medium with program code.

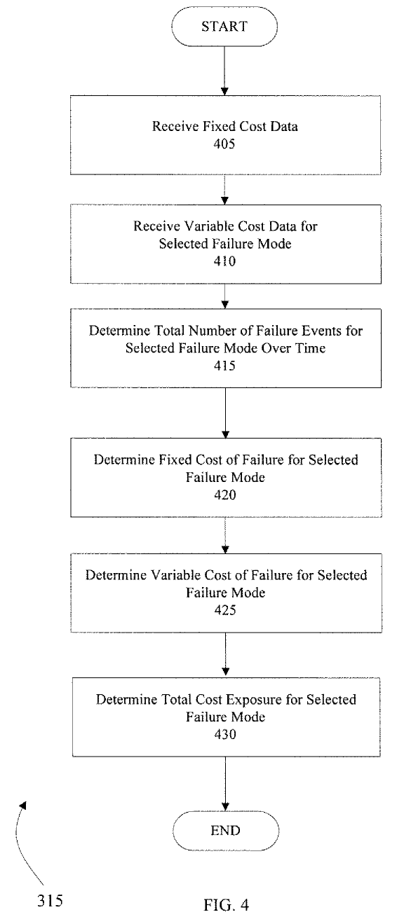

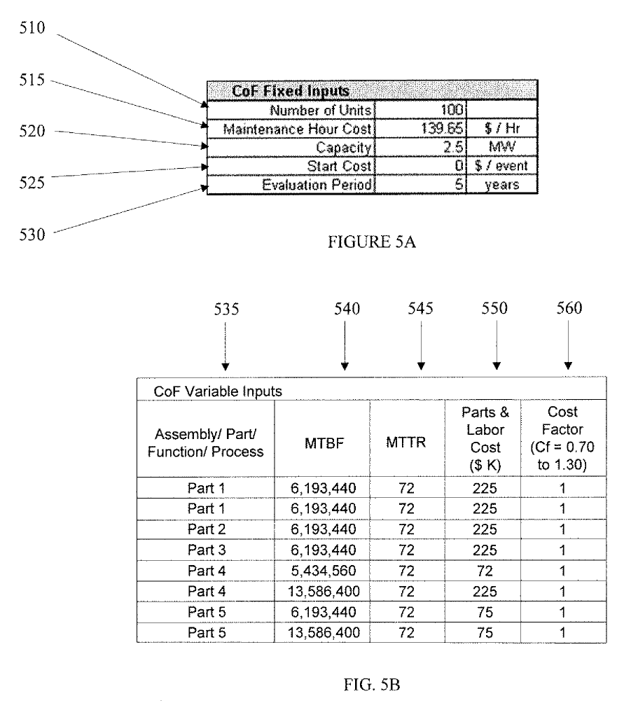

FIG. 5A is an exemplary chart that illustrates fixed cost data for an exemplary product that may be analyzed in accordance with certain embodiments of the invention. Specifically, FIG. 5A illustrates fixed cost data that may be used in a cost assessment for one example product; however, it will be appreciated that many different products may be utilized in association with embodiments of the invention. For example, fixed cost data may include the size of a product population as shown in row 510. In the example of FIG. 5A, the size of the product population may represent the total number of products that are incorporated into an exemplary system or device such as, for example, a power generation system. The fixed cost data may also include an evaluation period for the cost analysis, such as, for example, the evaluation period set for in row 525. The fixed cost data may also include a start cost associated with the product, as set forth in row 520. The fixed cost data may also include other costs associated with one or more failure modes for the product. Rows 515 and 520 represent other costs associated with one or more failures modes. Specifically, capacity and maintenance hour costs are illustrated in rows 515 and 520 respectively. In this example, the capacity may represent the lost power, and therefore lost profit, that may result while the product is shut down for repair. Similarly, the maintenance hour cost may represent the costs incurred from buying replacement energy while the power generation system is being repaired. Together, the capacity and maintenance hour costs serve as examples of other costs that may be associated with one or more failure modes; however, a wide variety of other costs will be appreciated by those skilled in the art.

As previously suggested, the fixed cost data may be associated with the selected failure mode or with a plurality of failure modes. For example, the start cost in row 525 may apply to a plurality of failure modes because all failures could lead to shut down and subsequent restart, thus incurring the same start cost.

FIG. 5B is an exemplary chart that illustrates variable cost data for an exemplary product that may be analyzed in accordance with certain embodiments of the invention. Specifically, FIG. 5B illustrates variable cost data that may be used in a cost assessment for the exemplary product in a power generation system discussed above with reference to FIG. 5A. Variable costs are displayed in FIG. 5B for parts or components of the product. Column 535 displays parts of the product that represent various failure modes for the product. Columns 540, 545, 550, and 560 respectively display variable costs associated with each failure mode of that part. Specifically, column 540 displays a Mean Time Between Failure (MTBF) for each failure mode; column 545 displays a Mean Time To Repair (MTTR) for each failure mode; column 550 displays a repair cost for each failure mode that may take various factors into account such as, for example, parts and labor costs; and column 560 displays other data associated with each failure mode.

The other data associated with each failure mode is represented as a cost factor in column 560. In this example, the cost factors reflect a maintenance complexity parameter associated with each failure mode. It will be appreciated that a variety of cost factors may be used. For example, a neutral maintenance task may be set to a cost factor of approximately 1.0 to reflect a normal expectation for completion of the maintenance task. A planned maintenance event may be less complex and time consuming, and therefore may be set to a cost factor of approximately 0.70 to reflect the efficiencies gained from having parts and repair personnel on hand prior to the commencement of the maintenance task. An unplanned maintenance event may be set to a cost factor of approximately 1.30 to reflect cost premiums associated with obtaining parts and repair personnel that are not readily available for an unplanned repair. Other cost factors that may be utilized in accordance with embodiments of the invention will be apparent to those skilled in the art.

FIG. 6 is an exemplary graphical user display showing cost analyzed and prioritized failure modes using the data provided in FIGS. 5A and 5D. Specifically, FIG. 6 illustrates an exemplary report 600 that may be generated by the control unit 140 for cost analyzed and prioritized failure modes for the example product that is described above with reference to FIG. 5. For example, column 605 lists system parts or components associated with the product, and column 610 lists failure modes for the various parts. As shown in FIG. 6, some components of the example product may be associated with one or more failure mode. The total cost exposure of the failure mode for a listed system part is given in column 660. The determined cost exposure may be based at least in part on the failure mode data, the fixed cost data, and/or the variable cost data, as described below. Column 665 displays the total cost exposure utilizing the product population from FIG. 5A row 510.

Moreover, FIG. 6 also displays the conventional method for analyzing failure modes. Under the conventional method, failure modes are analyzed according to their criticality and risk as determined by a failure mode's severity, the likelihood it would occur, and the likelihood it would be detected. In exemplary report 600, these values for the listed failure modes are presented in columns 625, 630, and 635 respectively. Using these factors, a rank priority number, or RPN, is assigned to each failure mode to represent that failure mode's criticality and risk. In exemplary report 600, a conventional RPN derived from a FEMA for each failure mode is displayed in column 640. The factors and RPN that are depicted in column 640 do not associate a cost analysis with the failure mode. It will be appreciated that the rank priority number may also be referred to as a risk priority number.

Exemplary report 600 displays the total cost exposure for each failure mode in column 660, and the total cost exposure for a specified population of the product in column 665. The total cost exposure is determined at least in part using a combination of the failure mode data, the fixed cost data, and/or the variable cost data. For example, column 645 illustrates the number of failure events that are expected for the evaluation period, which is established as 5 years for this example. As previously mentioned, the number of failure events may be received as part of the failure mode data, and/or it may be determined based at least in part on the fixed cost data and the variable cost data. In exemplary report 600, the number of failure events for each failure mode data is determined using the fixed cost data and the variable cost data from FIGS. 5A and 5B. Specifically, the number of failure events for each failure mode is determined as the product of the product population given in row 510 and the evaluation period given in row 530, with the result divided by the MTBF given in column 540.

With continued reference to FIG. 6, the exemplary report 600 displays the total cost exposure for each failure mode in column 660, and the total cost exposure for a specified population of the product in column 665. As previously described, the total cost exposure may be determined at least in part by using a combination of the fixed cost of failure and the variable cost of failure. The variable cost of failure, as described below, may be a function of the repair cost of failure and the lost operational cost of failure. Similarly, although the fixed cost of failure may be determined separately as described above, it may also be determined as part of the repair cost of failure and lost operational cost of failure.

For example, FIG. 6 column 660 displays the total cost of failure as a summation of the repair cost of failure and the lost operational cost of failure for selected failure modes of the product. In this example, the fixed cost of failure may be determined as a function of the repair cost of failure and lost operational cost of failure. For example, a fixed cost of failure may include a start cost as described above. If the repair cost of failure is defined as a function of the start cost, then it would also be defined as a function of the fixed cost of failure. Similarly, a fixed cost of failure may include a maintenance hour cost as described above. If the lost operational cost of failure is defined as a function of the maintenance hour cost, then it likewise would be defined as a function of the fixed cost.

The repair cost of failure is depicted in column 650 for the product. As previously described, the repair cost of failure for the selected failure mode may be determined at least in part by a combination of the failure mode data, the fixed cost data, and/or the variable cost data for the selected failure mode. In this example, the repair cost of failure for the selected failure mode is presented as a product of the number of failure events in column 645 and the summation of its repair costs and start costs in column 525 of FIG. 5A. The repair costs are presented as a product of the parts and labor costs in FIG. 5B column 550 and the cost factor in FIG. 5B column 560. In other embodiments, the repair costs may also be presented as a product of labor costs and a MTTR that is summed with the parts cost.

Exemplary report 600 displays the lost operational cost of failure in column 655 for an exemplary product in a power generation system. As previously described, the lost operational cost of failure for the selected failure mode may be determined at least in part by a combination of the failure mode data, the variable cost data, and/or the fixed cost data for the selected failure mode. In this example, the lost operational cost of failure for the selected failure mode is presented as a product of the number of failure events in column 645, the MTTR from FIG. 5B column 545, and the Maintenance Hour Cost from FIG. 5A column 515.

It will be appreciated that many different methods may be utilized to calculate or determine the various costs associated with one or more failure modes in accordance with other embodiments of the invention. The calculation methods described herein are merely exemplary calculation methods. It will also be appreciated that a wide variety of costs may be taken into account in the cost prioritization and analysis of one or more failure modes in accordance with other embodiments of the invention. The costs described herein are merely provided as exemplary costs that may be taken into account by the system 100.

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for analyzing failure modes derived from a failure modes and effects analysis for a product, comprising:
identifying one or more failure modes for the product; and
determining a respective cost exposure for at least one of the identified one or more failure modes.

2. The method of claim 1, wherein the product comprises at least one of a system, a component, or a process.

3. The method of claim 1, further comprising prioritizing the one or more failure modes according to the determined cost exposures.

4. The method of claim 1, further comprising storing data associated with the determined cost exposures.

5. The method of claim 1, further comprising generating one or more reports associated with the determined cost exposures.

6. The method of claim 1, further comprising displaying the cost analyzed failure mode information.

7. The method of claim 1, wherein determining a respective cost exposure for at least one of the one or more failure modes comprises:
identifying a total number of failure events associated with the analyzed failure mode; and
determining a total cost exposure for the analyzed failure mode based at least in part on the total number of failure events.

8. The method of claim 7, further comprising:
determining a fixed cost of failure for the analyzed failure mode;
wherein determining a total cost exposure is based at least in part on the determined fixed cost of failure.

9. The method of claim 7, further comprising:
determining a variable cost of failure for the analyzed failure mode;
wherein determining a total cost exposure is based at least in part on the determined variable cost of failure.

10. The method of claim 9, wherein determining the variable cost of failure comprises:
determining a repair cost of failure for the analyzed failure mode;
determining a lost operational cost of failure for the analyzed failure mode; and
determining the variable cost of failure based at least in part on the determined repair cost of failure and the determined operational cost of failure.

11. A system for analyzing failure modes associated with a product, comprising:
at least one memory operable to store data associated with at least one failure mode associated with the product; and
a processor operable (i) to identify one or more failure modes associated with the product, (ii) to access the stored data associated with the identified one or more failure modes, and (iii) to determine, based at least in part on the accessed data, a respective cost exposure for each of the one or more failure modes.

12. The system of claim 11, wherein the stored data comprises one or more of (i) identification data associated with at least one of the one or more identified failure modes, (ii) data associated with one or more fixed costs associated with at least one of the one or more identified failure modes, and (iii) data associated with one or more variable costs associated with at least one of the one or more identified failure modes.

13. The system of claim 11, wherein the stored data comprises one or more of (i) data associated with a respective failure rate for each of the one or more identified failure modes, and (ii) data associated with a respective evaluation period for each of the one or more identified failure modes.

14. The system of claim 11 wherein the processor is further operable to prioritize the identified one or more failure modes based on the determined cost exposures.

15. The system of claim 11, wherein the processor is further operable to cause at least one memory to store the cost analyzed failure modes based on the determined cost exposure.

16. The system of claim 14, wherein the processor is further operable to generate one or more reports associated with the prioritized one or more failure modes or to generate summary data associated with the prioritized one or more failure modes.

17. The system of claim 11 wherein the processor determines a respective cost exposure associated with each of the one or more identified failure modes by:
(i) determining a fixed cost of failure for an analyzed failure mode;
(ii) determining a variable cost of failure for the analyzed failure mode; and
(iii) determining a total cost exposure for the analyzed failure mode based at least in part on the determined fixed cost of failure and the determined variable cost of failure.

18. The system of claim 17, wherein the processor determines a variable cost of failure for the analyzed failure mode by:
(i) determining a repair cost associated with the analyzed failure mode;
(ii) determining a lost operational cost associated with the analyzed failure mode; and
(iii) determining the variable cost of failure for the analyzed failure mode based at least in part on the determined repair cost and the determined operational cost.

19. The system of claim 11, further comprising at least one output device operable to display at least a portion of the determined cost exposures.

20. A computer-readable medium with program code operable to:
identify one or more failure modes for a product;
access stored data associated with the product;
determine, based at least in part on the accessed data, a respective cost exposure for at least one of the identified one or more failure modes; and
prioritize the identified one or more failure modes based on the determined cost exposures.
